(19) United States
(12) Patent Application Publication
(10) Pub. No.: US 2013/0106290 A1
(43) Pub. Date: May 2, 2013

(54) ILLUMINATING APPARATUS CAPABLE OF MINIMIZING OCCURRENCE OF FLICKS AND METHOD USING THE SAME

(71) Applicants: CHIA-TIN CHUNG, MIAOLI COUNTY (TW); SHIH-NENG TAI, TAOYUAN COUNTY (TW)

(72) Inventors: CHIA-TIN CHUNG, MIAOLI COUNTY (TW); SHIH-NENG TAI, TAOYUAN COUNTY (TW)

(73) Assignee: PARAGON SEMICONDUCTOR LIGHTING TECHNOLOGY CO., LTD ., New Taipei City (TW)

(21) Appl. No.: 13/286,317

(22) Filed: Nov. 1, 2011

(51) Int. Cl. H05B 37/02

(52) U.S. Cl. 315/121

(57) ABSTRACT

An illuminating apparatus is disclosed. The illuminating apparatus includes a detecting unit, an illuminating unit, and a control unit. The illuminating unit includes multiple illuminating sets and a switching unit for adjusting a connection relationship among the illuminating sets to ensure a conducting voltage of the illuminating set to swing between a minimum conducting voltage and a maximum conducting voltage. The detecting unit is for detecting an inputted power source received by the illuminating unit. The control unit based on a detected inputted power source controls an operation of the switching unit for extending a conducting time in a single period of the inputted power source.

### BACKGROUND OF THE INVENTION

1. Field of the Invention

The present invention relates to an illuminating apparatus and a method using the same, and more particularly, to an illuminating apparatus capable of minimizing an occurrence of flicks and a method using the same.

2. Description of Related Art

As technology progresses, light emitting diodes (LED) have been gaining their popularity as an alternative means for lighting as they are generally associated with lower power consumption, higher brightness, and extended shelf time. Please refer to FIG. 1 as a schematic diagram of a traditional illuminating apparatus. The illuminating apparatus includes a rectifying circuit 90, an illuminating set 92 having multiple LED connected in series, and a current source 94. The rectifying circuit 90 could be a full-wave rectifying circuit receiving an alternating current (AC) before generating pulsed direct current (DC) as an inputted power supply for the illuminating set 92. The current source 94 is for providing a stable current with the LEDs in the illuminating set 92. And when more serially connected LEDs are conducted, the current source 94 is required to provide the current of a larger value as the result of an increase in a conducting voltage for the illuminating set 92.

When the conducting voltage for the illuminating set 92 increases, the pulsed DC-based inputted power supply needs to be larger than the conducting voltage for the illuminating set 92 to be conducted. In other words, the increased conducting voltage for the illuminating set 92 corresponds to a shorter conducting time for the same, resulting in more occurrences of flicks.

### SUMMARY OF THE INVENTION

The primary objective of the present invention is to provide an illuminating apparatus to minimize the occurrence of the flicks.

The disclosed illuminating apparatus includes an illuminating unit, a detecting unit, and a control unit. The illuminating unit includes multiple illuminating sets and a switching unit. The switching unit is for adjusting a connection relationship among the illuminating sets in order to ensure a conducting voltage of the illuminating unit to swing between a maximum conducting voltage and a minimum conducting voltage, with the minimum conducting voltage as a conducting voltage of the illuminating set. The detecting unit is for detecting the inputted power source with the control unit coupled between the detecting unit and the switching unit for controlling the conducting voltage of the illuminating unit to vary according to a variation in the inputted power source.

One embodiment of the present invention further includes the illuminating method applied in an illuminating apparatus having a control unit, a detecting unit, and an illuminating unit having multiple illuminating sets and a switching unit for adjusting a connection relationship among the illuminating sets. The method is for ensuring a conducting voltage of the illuminating unit to swing between a maximum conducting voltage and a minimum conducting voltage of the illuminating unit with the minimum conducting voltage as a conducting voltage of the illuminating set when the illuminating set is conducted. The method further includes detecting an inputted power source received by the illuminating set by the control unit through the detecting unit, and allowing for the control unit to control an operation of the switching unit according to the detected inputted power source so that the conducting voltage of the illuminating unit could swing between the minimum conducting voltage and the maximum conducting voltage.

To sum up, the illuminating apparatus according to the present invention may adjust the conducting voltage of the illuminating unit thereof for extending a conducting time of the illuminating unit in a period of the inputted power source, effectively reducing the occurrence of the flicks.

In order to further the understanding regarding the present invention, the following embodiments are provided along with illustrations to facilitate the disclosure of the present invention.

### BRIEF DESCRIPTION OF THE DRAWINGS

FIG. 1 shows a schematic diagram of a traditional illuminating apparatus;

FIG. 2 shows a simplified block diagram of an illuminating apparatus according to another embodiment of the present invention;

FIG. 3 illustrates a flow chart of an illuminating method using the illuminating apparatus according to one embodiment of the present invention;

FIG. 4 is a simplified block diagram illustrating an illuminating apparatus having an inputted power supply incorporated according to one embodiment of the present invention;

FIG. 5 illustrates a flow chart of an illuminating method using an illuminating apparatus according to one embodiment of the present invention;

FIG. 6 illustrates a waveform of an inputted power source; and

FIG. 7 illustrates a flow chart of an illuminating method using an illuminating apparatus according to one embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

The present invention relates to an illuminating apparatus that is capable of minimizing the occurrence of flicks and a method using the same. The disclosed illuminating apparatus includes an illuminating array consisted of multiple light emitting diodes (LED). The illuminating apparatus according to the present invention may detect a power supply received by the illuminating array (e.g., an inputted power supply) before adjusting a number of conducted LEDs. Accordingly, a conducting voltage for the illuminating array may become adjustable on basis of a variation in the inputted power supply from an inputted power source, for deceasing a dark zone period during which the illuminating apparatus illuminates no light within a single period of the inputted power source.

### First Embodiment of Illuminating Apparatus

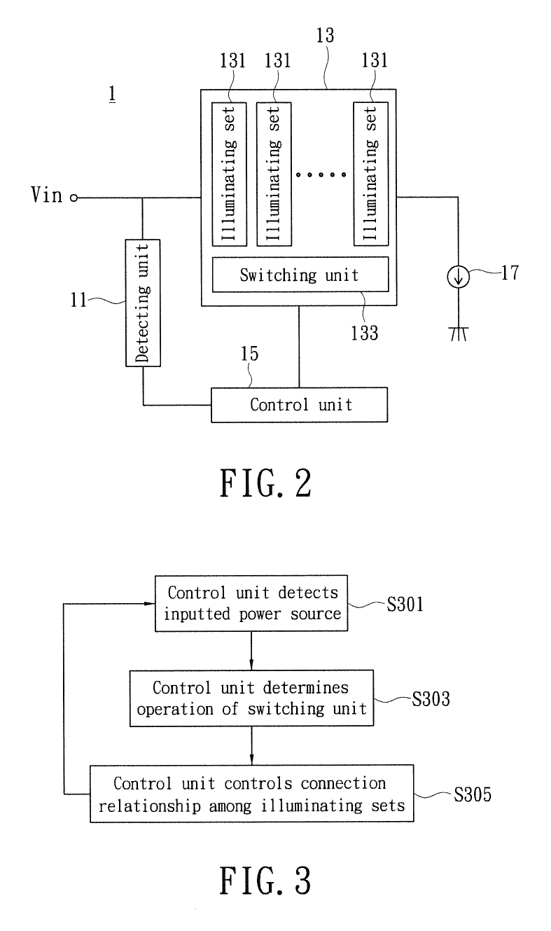

Referring to FIG. 2 in which a simplified block diagram of an illuminating apparatus 1 according to an embodiment of the present invention is illustrated. The illuminating apparatus 1 includes a detecting unit 11, an illumination unit 13, and a control unit 15.

The detecting unit 11 may be coupled the inputted power source, the illumination unit 13, and the control unit 15. The detecting unit 11 may be configured to detect a status of the inputted power source and deliver a detection result to the control unit 15. For example, the detecting unit 11 may detect phase variation and voltage variation of the inputted power source. In order to detect the phase variation and the voltage variation of the inputted power source, the detecting unit 11 may include a phase detecting circuit and/or a voltage detecting circuit. The inputted power source in the following description may be of a pulsed DC in the form of full waves or half waves that is an end product of a rectified AC. It is worth noting that the full-wave pulsed DC serving as an example of the inputted power source is applied in embodiments illustrated in subsequent paragraphs.

The illumination unit 13 may include a plurality of illumination sets 131 and a switching unit 133. In one implementation, the illumination set 131 includes multiple LEDs connected in series. In another implementation, the multiple LEDs may be connected in parallel. And the illumination set 131 may be conducted when receiving the inputted power source that is larger than the conducting voltage of the illumination set. It is worth noting that numbers of the LEDs in the illumination sets 131 may vary, and the conducting voltages among the illumination sets may not be the same.

The switching unit 133 may be configured to adjust connection relationships among the illumination sets 131. In one implementation, the switching unit 133 may cause just one illumination set 131 to be conducted, while in another implementation more than one illumination set 131 may be conducted. The switching unit 133 may include multiple switching components. In one implementation, the switching components may be implemented in the form of bipolar junction transistors (BJT), metal-oxide-semiconductor field-effect transistors (MOSFET), or relays.

The control unit 15 may be coupled between the detecting unit 11 and the illumination unit 13. As such, the control unit 15 may control operations of the switching unit 133 in order to further control whether the illumination set 131 may illuminate the light. In one implementation, the control unit 15 may be a micro-controller.

Since the control unit 15 may control the operations of the switching unit 133 according to the detection result from the detecting unit 11, the connection relationship among the illumination sets 131 may be dictated by the phase variation and/or the voltage variation of the inputted power source. The conducting voltage of the illumination sets 131 may be at least equal to the conducting voltage of the illumination set 131 that is conducted while other illumination sets 131 are not conducted. The conducting voltage of the illumination sets 131 may be capped by the sum of the conducting voltages of all the illumination sets 131 when every illumination set 131 is conducted.

More specifically, when the phase of the inputted power source is at zero the inputted power source in terms of the voltage level may not conduct any illumination set 131, leading to the control unit 15 not to control the operation of the switching unit 133 for adjusting the connection relationship among the illumination sets 131. On the other hand, when the phase of the inputted power source is no longer at zero with the corresponding voltage level thereof larger than the conducting voltage required for the conduction of one illuminating set 131 the control unit 15 may control the switching unit 133 at this particular point.

In practice, the control unit 15 may have one or more sets of predetermined values stored therein. The predetermined values may be further compared with the detection result of the detecting unit 11 and the corresponding comparison may serve as the basis for the adjustment of the operations of the switching unit 133. In one implementation, the predetermined value could be the conducting voltage of the illuminating set 131. In another implementation, the predetermined value could be the sum of the conducting voltages of more than one illuminating set 131.

The illuminating apparatus 1 may further include a current source 17 coupled to the illuminating unit 13. And the current source 17 may provide a stable current when one or more illuminating sets 131 are conducted. In another implementation, the current source 17 may be a controllable current source that is controlled by the control unit 15. The controllable current source 17 may thus serve as a source capable of providing different currents with the illuminating sets 131 with the provided currents depending on different conducting voltages of the illuminating sets 131 or illumination requirement associated with the illuminating apparatus 1.

### First Embodiment of Illuminating Method

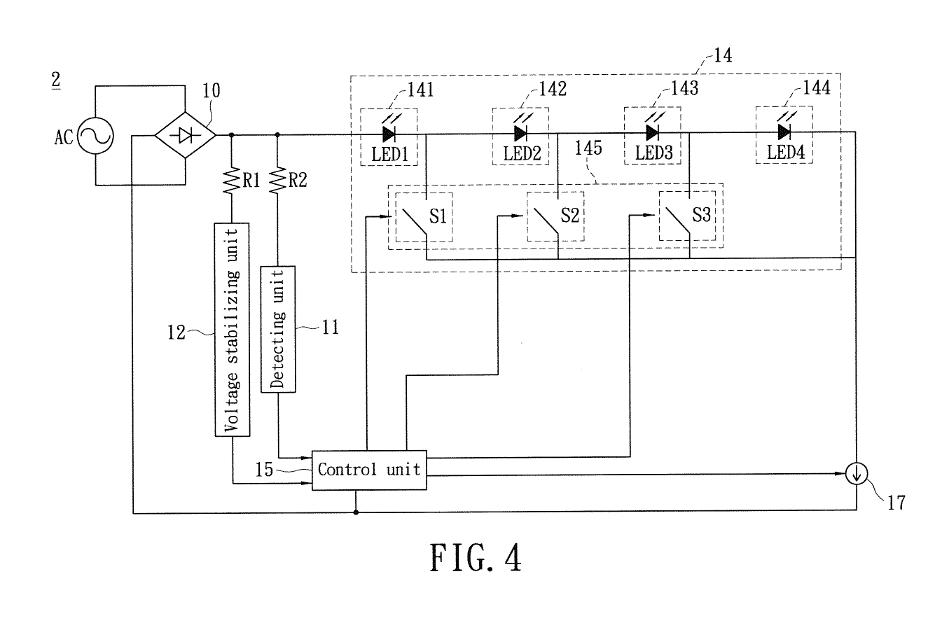

In conjunction with FIG. 2, FIG. 3 illustrates a flow chart of an illuminating method using the illuminating apparatus according to one embodiment of the present invention.

The illuminating method shown in FIG. 3 may include following steps. In step S301, the control unit 15 detects a status of the inputted power source through the detecting unit 11. The status of the inputted power source in one implementation may be the voltage level or the phase of the inputted power source. In step S303, the control unit 15 may determine whether the detected status may correspond to the predetermined value. And in step S305 the control unit 15 may therefore control the operations of the switching unit 133 and thus the connection relationship among the illuminating sets 131. After step S305, step S301 may be repeated until the illuminating apparatus 1 is turned off.

### Second Embodiment of Illuminating Apparatus

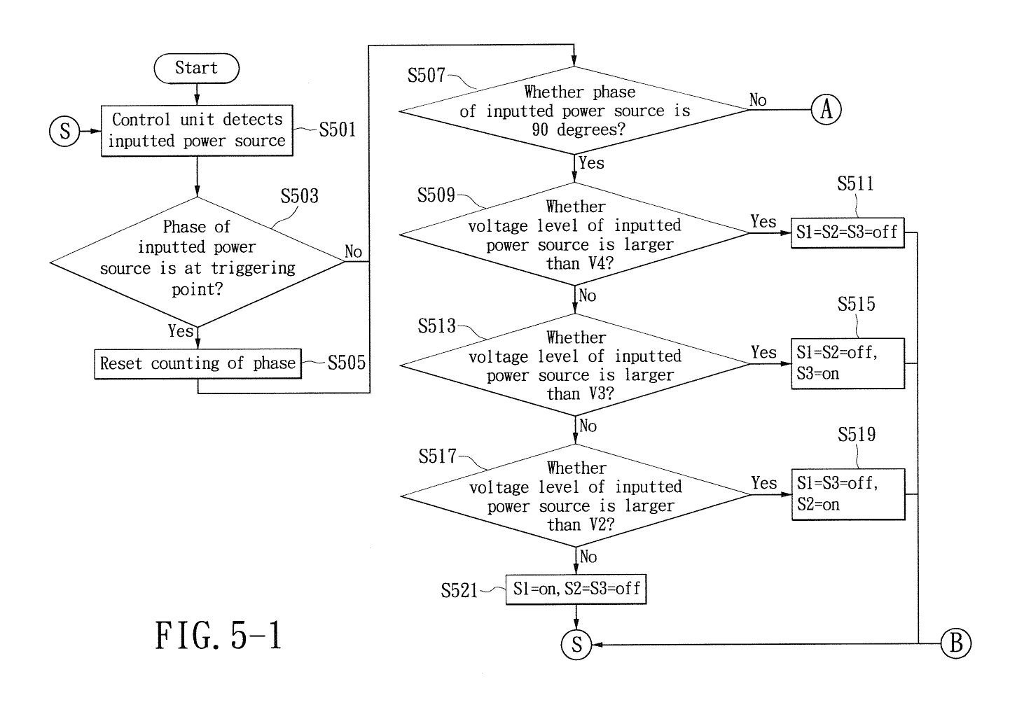

FIG. 4 is a simplified block diagram illustrating an illuminating apparatus 2 having an inputted power supply incorporated according to one embodiment of the present invention. The illuminating apparatus 2 may include a rectifying unit 10, the detecting unit 11, a voltage stabilizing unit 12, an illuminating unit 14, the control unit 15, and the current source 17.

The rectifying unit 10 may be coupled to the detecting unit 11, the voltage stabilizing unit 12, and the illuminating unit 14. The control unit 15, meanwhile, may be coupled to the detecting unit 11, the voltage stabilizing unit 12, the illuminating unit 14, and the current source 17.

In one implementation, the rectifying unit 10 is a full-wave rectifier rectifying AC waveforms before rectified signals, which may be the full-wave DC pulses, could be received and utilized by the illuminating unit 14. In another implementation, the rectifying unit 10 is a half-wave rectifier.

The voltage stabilizing unit 12 may stabilize the inputted power source in order to output a DC voltage source at a fixed voltage level for use of the control unit 15.

The illuminating unit 14 may include a first illuminating set 141, a second illuminating set 142, a third illuminating set 143, a fourth illuminating set 144, and a switching unit 145. It is worth noting that the first illuminating set 141, the second illuminating set 142, the third illuminating set 143, and the fourth illuminating set 144 may be connected in series, with one end of the first illuminating set 141 serving to receive the inputted power source.

The first illuminating set 141, the second illuminating set 142, the third illuminating set 143, and the fourth illuminating set 144 may be implemented in terms of a light emitting diode (LED). In other words, the first illuminating set 141 may be LED 1, the second illuminating set 142 may be LED 2, the third illuminating set 143 may be LED 3, and the fourth illuminating set 144 may be LED 4. It is worth noting that each illuminating set may consist of multiple LEDs connected in series or parallel.

The switching unit 145 may include a first switching component S1, a second switching component S2, and a third switching component S3. The first switching component S1 may be coupled between the first illuminating set 141 and the current source 17, while the second switching component S2 may be coupled between the second illuminating set 142 and the current source 17. Meanwhile, the third switching component S3 may be coupled between the third illuminating set 143 and the current source 17. In one implementation, the first switching component S1, the second switching component S2, and the third switching component S3 may be mechanical switches or electronic switches. When the switching components S1-S3 are electronic switches, they may be implemented in terms of BJTs, MOSFETs, relays, or combinations thereof.

When the first switching component S1, the second switching component S2, and the third switching component S3 are not conducted (or not turned on), the first illuminating set 141, the second illuminating set 142, the third illuminating set 143, and the fourth illuminating set 144 may be connected in series and could be conducted (turned on). Additionally, when the first switching component S1 and the second switching component S2 are not conducted but the third switching component S3 is conducted the first illuminating set 141, the second illuminating set 142, and the third illuminating set 143 may be sequentially connected in series and could be further conducted.

When the first switching component S1 and the third switching component S3 are not conducted but the second switching component S2 is conducted, the first illuminating set 141 and the second illuminating set 142 may be sequentially connected in series and could be further conducted. Also, when the first switching component S1 but the second switching component S2 and the third switching component S3 are not conducted only the first illuminating set 141 could be further conducted.

The illuminating sets 141-144 may be controlled by the switching components S1-S3, respectively, in order to collectively form a closed circuit with one or more illuminating sets 141-144 in operation. As such, the conducting voltage of the illuminating unit 14 may swing between a maximum conducting voltage and a minimum conducting voltage. In one implementation, the maximum conducting voltage may be the sum of the conducting voltages of the illuminating sets 141-144 when the illuminating sets 141-144 are serial connected to the current source 17. In one implementation, the minimum conducting voltage is the conducting voltage of the first illuminating set 141 when the first illuminating set 141 is the only illuminating set conducted.

The control unit 15 may control the operations of the switching components S1-S3 according to the detection result. As previously mentioned, the control unit 15 may pre-store a set of the predetermined values, each of which may correspond to a distinct way fir the control unit 15 to control the switching unit 145. Since the detection result from the detecting unit 11 indicates the status of the inputted power source, the control unit 15 may control the switching unit 145 following whether the detection result matches the predetermined value so that the illuminating unit 14 could be in operation with the current inputted power source. And when the detection result matches the predetermined value the control unit 15 may further control the current source 17 to adjust a current value of the current supplied to the illuminating unit 14. For example, when the conducting voltage for the illuminating unit 14 varies from low to high the current value of the current supplied to the illuminating unit 14 may vary from high to low accordingly.

### Second Embodiment of Illuminating Method

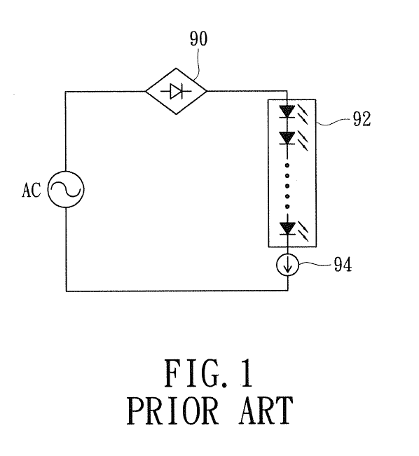

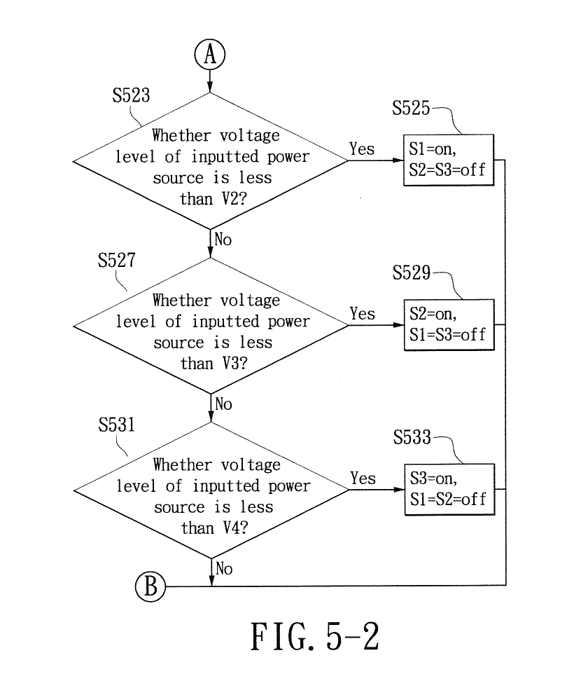

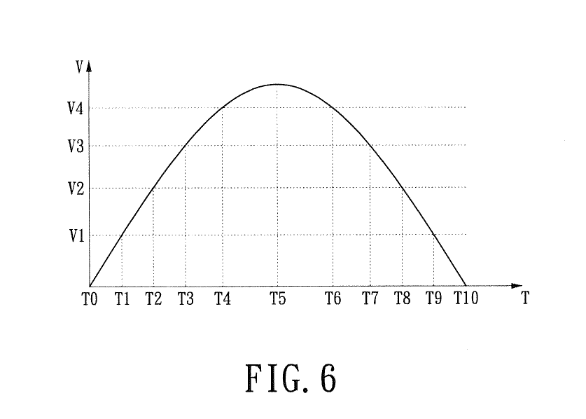

Please refer to FIG. 5 illustrating a flow chart of an illuminating method using an illuminating apparatus according to one embodiment of the present invention in conjunction with FIGS. 4 and 6, where FIG. 6 illustrates a wave form of an inputted power source. It is worth noting that the flow chart illustrated the illuminating method using the illuminating apparatus is shown in both FIG. 5-1 and FIG. 5-2.

The waveform of the inputted power source may indicate the requirement of the conducting voltage for the illuminating unit 14. According to FIG. 6, the phase and the voltage level of the inputted power source may be zero at T0.

When the waveform shown in FIG. 6 is at T1 where the phase of the inputted power source is larger than zero and the inputted power source corresponds to a first conducting voltage V1, a single illuminating set (e.g., the first illuminating set 141) may be conducted as the first conducting voltage T1 is sufficient for one illuminating set to be conducted.

When the waveform is at T2 corresponding to the phase of the inputted power source larger than zero and a second conducting voltage V2, two serially connected illuminating sets including the first illuminating set 141 and the second illuminating set 142 may be conducted at the same time. Similarly, when the waveform is at T3 where the phase of the inputted power source is still larger than zero with the voltage level of the inputted power source standing at a third conducting voltage V3 three illuminating sets (e.g., illuminating sets 141-143) that are serially connected together may be conducted at the same time. When the waveform is at T4 corresponding to the phase of the inputted power source larger than zero and the voltage level of the same at a fourth conducting voltage V4, four illuminating sets 141-144 that are serially connected may be conducted.

The flow chart shown in FIG. 5 includes step S501 in which the control unit 15 detects the phase and the voltage level of the inputted power source by the detecting unit 11. The method illustrated in FIG. 5 also includes determining whether the phase of the inputted power source is at a triggering point (step S503). In one implementation, the triggering point is at the phase zero of the inputted power source.

When the phase of the inputted power source is at T0, the illuminating method may further include resetting the counting of the phase in step S505 before proceeding to step S507 in which the control unit 15 may determine whether the phase of the inputted power source is less than 90 degrees.

When the phase of the inputted power source is less than 90 degrees in step S507, the illuminating method may further include determining whether the voltage level of the inputted power source is larger than the fourth conducting voltage V4 as shown in step S509.

When the voltage level of the inputted power source is larger than the fourth conducting voltage V4 in step S509, the control unit 15 may cause the first switching component S1, the second switching component S2, and the third switching component S3 not to be conducted, further resulting in the first illuminating set 141, the second illuminating set 142, the third illuminating set 143, and the fourth illuminating set 144 to be sequentially and serially connected to the current source 17 and could be conducted (step S511).

Otherwise, the illuminating method may further determine whether the voltage level of the inputted power source is larger than the third conducting voltage V3 in step S513. If so, the control unit 15 may control the first switching component S1 and the second switching component S2 not to be conducted while causing the third switching component S3 to be conducted. Therefore, the first illuminating set 141, the second illuminating set 142, and the third illuminating set 143 could be sequentially and serially connected to the current source 17 and could be conducted in step S515.

When the determination in step S513 is negative, the illuminating method may further determine whether the voltage level of the inputted power source is larger than the second conducting voltage V2 in step S517. If so, the control unit 15 may control the first switching component S1 and the third switching component S3 not to be conducted while causing the second switching component S2 to be conducted. Therefore, the first illuminating set 141 and the second illuminating set 142 could be sequentially and serially connected to the current source 17 and could be conducted in step S519.

Otherwise, the control unit 15 may cause the first switching component S1, the second switching component S2, and the third switching component S3 not to be conducted, resulting in only the first illuminating set could be in connection with the current source 17 and could be conducted, before the illuminating method returns to step S501.

When step S507 determines that the phase of the inputted power source is larger than 90 degrees, the illuminating method may further include determining whether the voltage level of the inputted power source is less than the second conducting voltage V2 as shown in step S523.

When step S523 determines that the voltage level of the inputted power source is less than the second conducting voltage V2, the control unit 15 may cause the first switching component S1 to be conducted while causing the second switching component S2 and the third switching component S3 not to be conducted, also resulting in only the first illuminating set 141 could be in connection with the current source 17 and could be conducted (step S525).

When step S523 determines that the voltage level of the inputted power source is larger than the second conducting voltage V2, the illuminating method may further determine whether the third conducting voltage V3 has not been exceeded by the voltage level of the inputted power source (step S527). If so, the control unit 15 may cause the first switching component S1 and the third switching component S3 not to be conducted but causing the second switching component S2 to be conducted, enabling the first illuminating set 141 and the second illuminating set 142 to be sequentially and serially connected to the current source 17 for conduction (step S529).

When the voltage level of the inputted power source is larger than the third conducting voltage V3, the illuminating method may further determine whether the current voltage level of the inputted power source is less than the fourth conducting voltage V4 in step S531. If so, the control unit 15 may cause the first switching component S1 and the second switching component S2 not to be conducted but causing the third switching component S3 to be conducted, enabling the first illuminating set 141, the second illuminating set 142, and the third illuminating set 143 to be sequentially and serially connected to the current source 17 for conduction (step S533). If not, the illuminating method may return to step S501.

It is worth noting that steps S501-S533 are for the illustration of a single period (from zero degree to one hundred and eighty degrees in phase) of the inputted power source.

To summarize, when the voltage level of the inputted power source increases when the waveform of the inputted power source swings beginning from zero degree to ninety degrees in phase the conducting voltage of the illuminating unit 14 may be adjusted from the minimum conducting voltage to the maximum conducting voltage accordingly. On the other hand, when the voltage level of the inputted power source decreases when the waveform of the same swings from ninety degrees to one hundred and eighty degrees in phase the conducting voltage of the illuminating set 14 may be adjusted from the maximum conducting voltage to the minimum conducting voltage.

### Third Embodiment of Illuminating Method

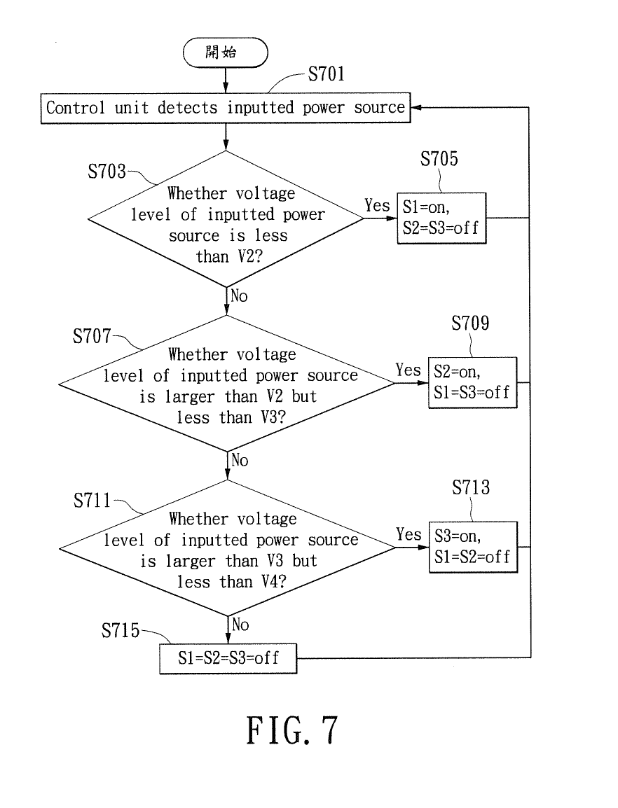

FIG. 7 illustrates a flow chart of an illuminating method using an illuminating apparatus according to one embodiment of the present invention. For the illustration purpose, please refer to FIG. 7 in conjunction with FIGS. 4 and 6.

The flow chart shown in FIG. 7 includes step S701 in which the control unit 15 detects the phase and the voltage level of the inputted power source by the detecting unit 11. The method illustrated in FIG. 7 also includes determining whether the voltage level of the inputted power source is less than the second conducting voltage V2 (step S703).

When the voltage level of the inputted power source is less than V2, the control unit 15 may be configured to cause the first switching component S1 to be conducted while causing both the second switching component S2 and the third switching component S3 not to be conducted, resulting in the first illuminating set 141 is the only illuminating set connected to the current source 17 and therefore may be ready for conduction (step S705).

Otherwise, the illuminating method may further include determining whether the voltage level of the inputted power source is less than the third conducting voltage V3 as shown in step S707. When the voltage level of the inputted power source is less than the V3, the control unit 15 may cause the first switching component S1 and the third switching component S3 not to be conducted while causing the second switching component S2 to be conducted, further resulting in the first illuminating set 141 and the second illuminating set 142 are the illuminating sets sequentially and serially connected to the current source 17 for further conduction (step S709).

Otherwise, the illuminating method may further determine whether the voltage level of the inputted power source is less than the fourth conducting voltage V4 in step S711. If so, the control unit 15 may control the first switching component S1 and the second switching component S2 not to be conducted while causing the third switching component S3 to be conducted. Therefore, the first illuminating set 141, the second illuminating set 142, and the third illuminating set 143 could be sequentially and serially connected to the current source 17 and could be conducted in step S713.

When the determination in step S711 is negative, the control unit 15 may be configured to control the first switching component S1, the second switching component S2, and the third switching component S3 not to be conducted. Therefore, the illuminating sets 141-144 could be sequentially and serially connected to the current source 17 for conduction in step S715, before the entire flow returns to step S701.

Otherwise, the control unit 15 may cause the first switching component S1, the second switching component S2, and the third switching component S3 not to be conducted, resulting in only the first illuminating set could be in connection with the current source 17 and could be conducted, before the illuminating method returns to step S501.

It is worth noting that steps S701-S715 illustrate an example of a period from zero degree to one hundred and eighty degrees in phase of the inputted power source.

The illuminating apparatus may thus utilize the inputted power source of different values to dynamically adjust the conducting voltage of the illuminating unit to be swinging between the minimum conducting voltage and the maximum conducting voltage. As such, the conducting voltage for the illuminating unit could be set to satisfy minimum requirement for the conduction, therefore enhancing the illuminating efficiency of the illuminating unit and minimizing the occurrence of the flicks associated with the illuminating unit.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. An illuminating apparatus, comprising:
an illuminating unit having a plurality of illuminating sets and a switching unit controlling a connection relationship among the illuminating sets for ensuring the illuminating unit to be conducted between a maximum conducting voltage and a minimum conducting voltage;
a detecting unit for detecting an inputted power source received by the illuminating unit; and
a control unit coupled to the detecting unit and the switching unit, for adjusting the conducting voltage of the illuminating unit by controlling an operation of the switching unit according to the detecting unit detecting the inputted power source received by the illuminating unit.

2. The illuminating apparatus according to claim 1, wherein the control unit controls the operation of the switching unit for causing the conducting voltage of the illuminating unit to be adjusted according to a variation in the inputted power source so long as a voltage level of the inputted power source is larger than the minimum conducting voltage.

3. The illuminating apparatus according to claim 2, wherein the maximum conducting voltage is a sum of conducting voltages associated with the illuminating sets.

4. The illuminating apparatus according to claim 2, wherein each illuminating set comprises at least one light emitting diode (LED).

5. The illuminating apparatus according to claim 2, wherein the detecting unit comprises a phase detecting circuit for detecting a phase of the inputted power source so that the control unit controls the operation of the switching unit according to a variation in the phase of the inputted power source, so as to ensure the conducting voltage of the illuminating unit to swing between the maximum conducting voltage and the minimum conducting voltage.

6. The illuminating apparatus according to claim 1, wherein the conducting unit comprises a plurality of switching components with operations of the switching components adjusting a number of the illuminating sets serially conducted.

7. The illuminating apparatus according to claim 2, further comprising a current source coupled to the illuminating unit for providing a stable current with the illuminating unit when the illuminating unit is conducted, and a rectifying unit for rectifying an alternating current into the inputted power source.

8. The illuminating apparatus according to claim 7, wherein the control unit controls the current source to supply the stable current of different values corresponding to the varied conducting voltage of the illuminating unit.

9. An illuminating method applied in an illuminating apparatus having a control unit, a detecting unit, and an illuminating unit with a plurality of illuminating sets and a switching unit, wherein the switching unit is configured to control a connection relationship among the illuminating sets for ensuring a conducting voltage of the illuminating unit to swing between a maximum conducting voltage and a minimum conducting voltage, the method comprising:
detecting an inputted power source received by the illuminating unit by the detecting unit; and
controlling an operation of the switching unit according to the detecting unit detecting the inputted power source received by the illuminating unit by the control unit, with the minimum conducting voltage as a conducting voltage of the illuminating set.

10. The illuminating method according to claim 9, wherein the control unit controls the operation of the switching unit for ensuring the conducting voltage of the illuminating unit to swing between the minimum conducting voltage and the maximum conducting voltage according to a variation in the inputted power source so long as a voltage level of the inputted power source is larger than the minimum conducting voltage.

11. The illuminating method according to claim 10, wherein the maximum conducting voltage is a sum of the conducting voltages associated with the illuminating sets.

12. The illuminating method according to claim 10, wherein the control unit detects a phase of the inputted power source by the detecting unit having a phase detecting circuit so that the control unit controls the operation of the switching unit according to a variation in the phase of the inputted power source, so as to ensure the conducting voltage of the illuminating unit to swing between the maximum conducting voltage and the minimum conducting voltage.

13. The illuminating method according to claim 9, wherein the control unit, according to the detecting unit detecting the inputted power source, causes a current source serving to provide a current with the illuminating unit when the illuminating unit is conducted, with a value of the current provided varying when the inputted power source swings between the maximum conducting voltage and the minimum conducting voltage.
